(19) United States
(12) Patent Application Publication
(10) Pub. No.: US 2002/0092605 A1
(43) Pub. Date: Jul. 18, 2002

(54) Method of applying veneer to a substrate

(76) Inventor: Roberto Scarimbolo, (US)

Correspondence Address: DENNISON ASSOCIATES, 133 RICHMOND ST. WEST, SUITE 301, TORONTO, ON, M5H 2L7, CA

(21) Appl. No.: 09/797,667

(22) Filed: Mar. 5, 2001

(30) Foreign Application Priority Data
Aug. 29, 2000 (CA) 2,317,163

(51) Int. Cl. B65C 1/00

(52) U.S. Cl. 156/212

(57) ABSTRACT

A method of veneering a substrate having adjacent surfaces joined by a rounded edge region comprises applying the veneer separately to each surface to produce a veneer overlap area at the rounded edge region. Thereafter the veneer at the overlap area is reduced to a thickness consistent with that of the veneer on the adjacent surfaces of the substrate.

### FIELD OF THE INVENTION

The present invention relates to a method of applying veneer to a rounded edge substrate to form products such as cupboard doors, table tops, etc.

### BACKGROUND OF THE INVENTION

It is well known in various different arts to cover lower quality substrates with higher quality skins in producing an expensive looking product. The woodworking art is no exception where substrates made of products such as chipboard, strawboard, MDF, HDF, etc. are covered with veneers of high end wood materials, e.g. oak, maple and other similar veneers.

The above woodworking process can be used to make panels which are then put to different uses such as cupboard doors, table tops, etc. In making these products, particularly decorative, the panels can be made with rounded edges. However, the application of the veneer to a rounded edge substrate can be difficult and expensive as a result of material wastage. The standard known method of carrying out this manufacturing process is to apply the veneer to the substrate with its rounded edge by means of a vacuum press. This press is in the form of a flexible membrane which forces a single piece of veneer onto the front surface around the edge and then onto the side edge surface of the substrate. The application of the veneer around the curvature between the front and side edge surfaces is very difficult and often results in uneven application or even cracking of the veneer material. When this occurs the starting materials, i.e. the substrate and the veneer material simply become waste and the entire process must be repeated.

### SUMMARY OF THE PRESENT INVENTION

The present invention relates to a method of surface treating a substrate with a veneer where the application of the veneer to a rounded edge on the substrate is much simpler and more efficient than prior art techniques.

More particularly, the present invention relates to a method of veneering a substrate having adjacent surfaces, e.g. a face and a bordering sidewall, joined by a rounded edge region of the substrate. The method comprises applying the veneer separately to each surface so as to produce a veneer overlap area at the rounded edge region. Thereafter the veneer at the overlap area is reduced to a thickness consistent with the veneer on the adjacent surfaces of the substrate.

With the above method, there is essentially no likelihood of damaging the veneer at the rounded edge region of the substrate resulting in substantial savings from both a material and time of production standpoint over prior art techniques.

### BRIEF DESCRIPTION OF THE DRAWINGS

The above as well as other advantages and features of the present invention will be described in greater detail according to the preferred embodiments of the present invention in which;

FIG. 1 shows a prior art set up for applying veneer to a rounded edge substrate;

FIG. 2 is an end view of a substrate used for carrying out the veneering method of the present invention;

FIGS. 3 through 7 show the sequential steps of applying veneer to the substrate of FIG. 2 according to a preferred embodiment of the present invention;

FIG. 8 is an end view of another substrate again used for carrying out the veneering method of the present invention;

FIGS. 9 through 11 show the sequential steps of applying veneer to the substrate of FIG. 8 according to a further preferred embodiment of the invention.

### DETAILED DESCRIPTION ACCORDING TO THE PREFERRED EMBODIMENTS OF THE PRESENT INVENTION IN WHICH

FIG. 1 shows a prior art set up for applying veneer, e.g. a wood veneer C to a substrate A. The substrate also has a wooden construction. However, the substrate is of lower quality wooden material as earlier mentioned and covered by the more expensive veneer.

In the prior art veneering method, substrate A is before receiving the veneer formed to include rounded edge regions B at the juncture of the front and side edge surfaces. A single piece of veneer is then applied by means of a flexible member D which, under vacuum, draws the veneer onto the front surface around the corners B and onto the side edge surfaces of the substrate.

The above manufacturing technique often results in distortions or even cracking of the veneer on the corner regions of the substrate.

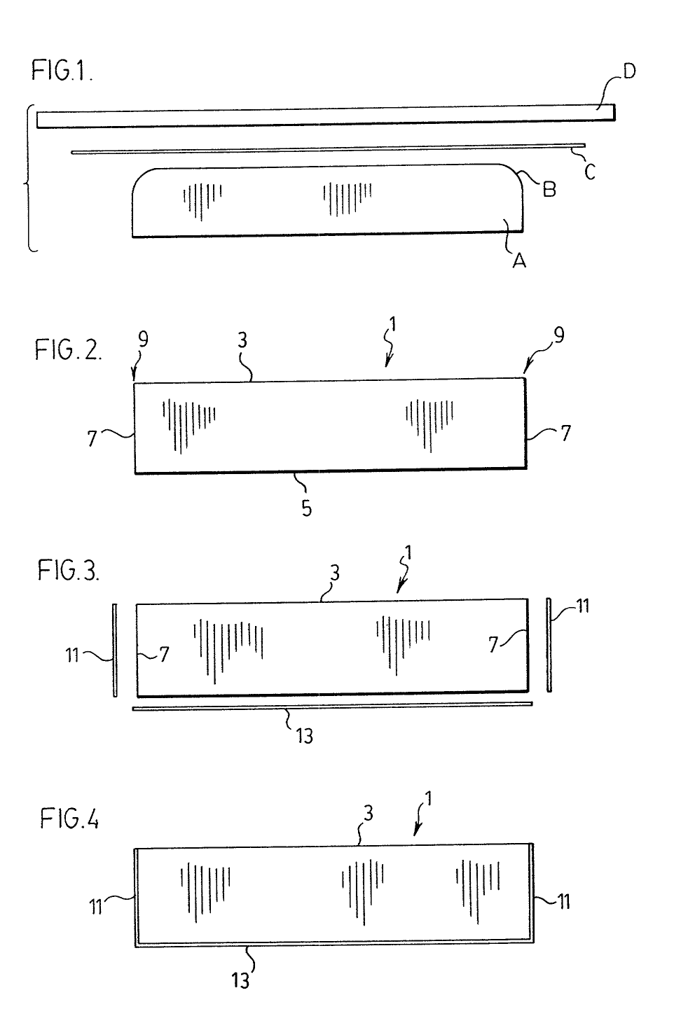

FIG. 2 shows a substrate generally indicated at 1 which, in accordance with the present invention, is ready to receive a surface coating of veneer. Like the earlier described prior art constructions, substrate 1 preferably has a relatively inexpensive wooden construction and the veneer to be applied as described below is of a much higher grade wooden construction. is to be noted in FIG. 2 that substrate 1 is formed with flat front and back faces 3 and 5 respectively and a sidewall 7 which meets at right angles with both the front and back faces of the substrate. In particular, the corner region generally indicated at 9 between the front face and the sidewall has a right angular construction.

The first step in the veneer application method in this embodiment comprises applying veneer coating 11 to the sidewall 7 of the substrate. Also in the embodiment shown in FIG. 3, a further veneer coating 13 is applied to the back face of the substrate as well. However, this is not necessary in as much as the back face 5 may be left untreated if desired.

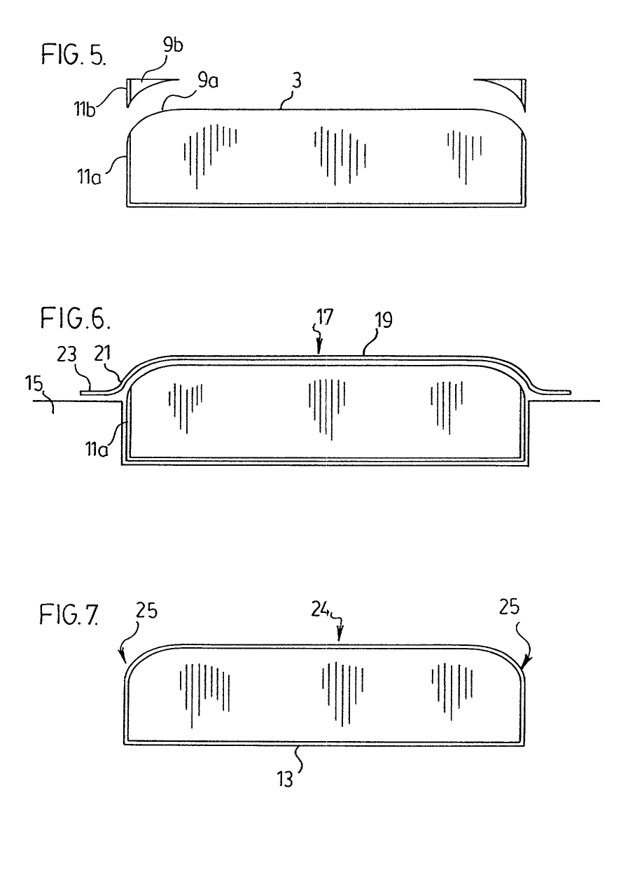

FIG. 4 shows the substrate 1 with the veneer coatings 11 and 13 adhered, i.e. glued to the substrate which is then ready for the next step in the process shown in FIG. 5 of the drawings.

As will be seen in FIG. 5, the substrate is then formed with a rounded edge region 9a at the juncture between its front face and the sidewall. This edge region is formed by means of a mechanical step such-as sanding or the like.

The rounding of the edge region results in the elimination of a corner piece 9b from the substrate. FIG. 5 shows the corner piece as having a unitary construction, however, it will be appreciated that through the sanding process, this corner piece is removed in particle form. The purpose of showing the corner piece as seen in FIG. 5 is to demonstrate that part of the veneer coating 11 is removed in the sanding process. The removed veneer part is indicated at 11b leaving a veneer surface 11a on the sidewall of the substrate.

The next step in the process involves the placement of the substrate from FIG. 5 into a jig or mold 15 shown in FIG. 6 of the drawings. Here it will be seen that the depth of the mold is such that the top of the veneer coating 11a on the sidewall of the substrate protrudes slightly outwardly of the mold.

With the substrate in the FIG. 6 position in the mold, a further coating of veneer, generally indicated at 17 is then applied by vacuum forming it downwardly onto the substrate. Veneer 17 typically matches the veneer 11 applied to the sidewall of the substrate, although it is equally possible to have two different veneers on the front face and the sidewall.

The veneer coating 17 comprises a main portion 19 which is applied directly to the front face 3 of the substrate and more minor outside portions 23 which go to the outside of the substrate. Under vacuum, the outside portions are pulled at the area indicated at 21 onto the substrate where they overlap the veneer coating 11a already applied to the sidewall of the substrate. Note from FIG. 6 that the veneer coating 17 is not pulled all the way around the sidewall of the substrate but only onto the overlapped region 21 as described above.

After the product has been prepared as shown in FIG. 6, the substrate with the veneer applied thereto is taken out of the jig and the excess loose veneer material of the end portions 23 removed from the substrate. The overlapped veneer region 21 is then sanded to produce an end product 24 having a rounded edge region 25 where the veneer at the overlap area is reduced to a thickness consistent with that on the front face and the sidewall. This gives the veneer the appearance of being a homogeneous or one piece layer on the substrate.

FIGS. 8 through 11 show a further embodiment of the invention again starting with a relatively inexpensive substrate generally indicated at 31. This substrate, like the earlier described substrate, would typically have an inexpensive wooden construction or it could be made from materials other than wood, e.g. plastic metal, aluminum, etc. Accordingly, it is to be understood that in all of the embodiments of the present invention, the substrate is not necessarily limited to a wooden construction.

Substrate 31 comprises opposite faces 33 and a sidewall 35 adjacent the opposite faces. The sidewall is joined with each face by means of a square corner region 37.

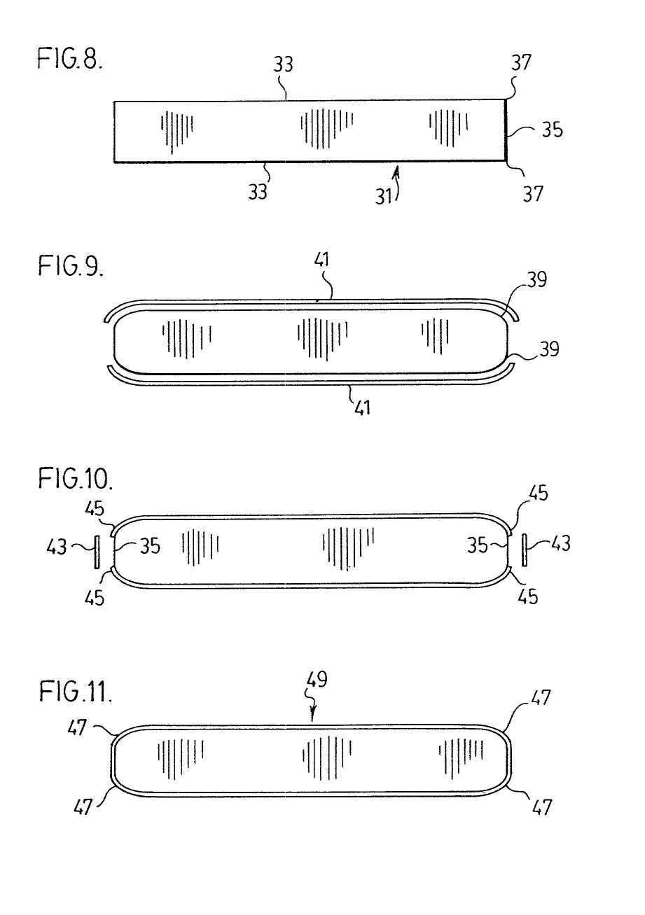

FIG. 9 shows that the first step in preparing this particular embodiment is to change the configuration of the corners from the square corners of FIG. 8 to the rounded corners of FIG. 9. With a wooden substrate, this would be done by a sanding process. This produces a rounded edge region between the sidewall and each face.

The next step in this particular embodiment is to apply veneer coatings 41 to the opposite faces 33 of the substrate.

The veneer coatings 41 additionally wrap around the rounded corner or edge regions 39 on the substrate as indicated at 45 in FIG. 10.

The application of the coatings 41 can be carried out by a vacuum press as earlier described. The substrate would be placed with one of its faces directly under the vacuum press with a coating 41 applied to that face. The substrate would then be flipped over to apply the veneer coating to the other face of the substrate.

Once the substrate is in the semi-veneered condition of FIG. 10 there remains a relatively short uncovered area 35 on the sidewall of the substrate. This area is then covered by a veneer coating 43. Coating 43 overlaps the already veneered corner region 45 of the substrate.

The final step in the process is to reduce the thickness of the veneer in the overlap area at the rounded edge region to either side of the substrate to a thickness consistent with that of the single layer of veneer on both the sidewall and each face of the substrate. This results in a veneer covered product generally indicated at 49 in FIG. 11 where the veneer on the rounded edge regions 47 have a uniform or homogeneous appearance with the veneer applied to the remainder of the substrate.

Although the embodiment of FIGS. 8 through 11 shows the application of veneer to both faces of the substrate, the method of this particular embodiment could equally as well be used to apply veneer to only one of the faces and the adjacent sidewall joined by the rounded edge region of the substrate. The other face, which would become the back face could be left untreated.

Although various preferred embodiments of the present invention have been described in detail, it will be appreciated by those skilled in the art that variations may be made without departing from the spirit of the invention or the scope of the appended claims.

The embodiments of the invention in which an exclusive property or privilege is claimed are defined as follows:

1. A method of veneering a substrate having adjacent surfaces joined by a rounded edge region of the substrate, said method comprising applying the veneer separately to each surface to produce a veneer overlap area at the rounded edge region and then reducing the veneer at the overlap area to a thickness consistent with that of the veneer on the adjacent surfaces.

2. A method as claimed in claim 1, wherein the surfaces to which the veneer is applied include a face and a sidewall of the substrate.

3. A method as claimed in claim 1, wherein the surfaces to which the veneer is applied include opposite faces and a sidewall of the substrate.

4. A method as claimed in claim 2, wherein the veneer is first applied to the sidewall, the rounded edge region is formed on the substrate and the veneer is then applied to the face around the edge region and onto the veneer applied to the sidewall to produce the veneer overlap area.

5. A method as claimed in claim 2, wherein the rounded edge region is first formed on the substrate, the veneer is applied to the face and around the rounded edge region and then the veneer is applied to the sidewall and onto the veneer applied to the face to produce the veneer overlap area.
